(19) United States
(12) Patent Application Publication
(10) Pub. No.: US 2008/0098297 A1
(43) Pub. Date: Apr. 24, 2008

(54) METHOD AND SYSTEM FOR PROVIDING PRESENCE INFORMATION

(76) Inventors: Qian SUN, Shenzhen (CN); Linyi Tian, Shenzhen (CN); Yang Zhao, Shenzhen (CN); Xuefei Song, Shenzhen (CN); Hongging Bao, Shenzhen (CN); Chenghui Peng, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/945,088

(22) Filed: Nov. 26, 2007

Related U.S. Application Data
(63) Continuation-in-part of application No. PCT/CN2006/003554, filed on Dec. 22, 2006.

(30) Foreign Application Priority Data
May 26, 2006 (CN) 200610060884.5

(51) Int. Cl. G06F 17/00; G06F 15/16

(52) U.S. Cl. 715/234; 709/204; 715/200

(57) ABSTRACT

The present invention discloses a method for providing presence information, including: setting a validity period of the presence information; publishing, by a presentity client, the received presence information and the validity period to a presence server; and distributing the received presence information and the validity period to a watcher client by the presence server. Thus, the watcher client knows the validity period of the presence information, such as an end time of a current presence time, and thereby selects timely an appropriate time for communication with the presentity client. Furthermore, the present invention also provides a start time of the current presence information, and thus the watcher client knows a duration of the current presence information of the presentity client. The present invention further discloses a system for providing presence information.

The present application is a Continuation-In-Part Application of PCT application PCT/CN2006/003554, filed on Dec. 22, 2006, entitled “METHOD AND SYSTEM FOR PROVIDING PRESENCE INFORMATION”, which is incorporated by reference herein in its entirety and which claims a priority from the Chinese Patent Application No. 200610060884.5, filed with the Chinese Patent Office on May 26, 2006, entitled “METHOD FOR PROVIDING PRESENCE INFORMATION”. Contents of the two applications are incorporated herein by reference in its entirety.

### FIELD OF THE INVENTION

The present invention relates to a presence service in the field of communications, and in particular to a method and system for providing presence information.

### BACKGROUND OF THE INVENTION

A presence service is a communication service for collecting and distributing presence information. Currently, this service is generally provided along with an instant message service. Alternatively, the presence service may also be provided separately or in combination with other services, such as network game. The presence information typically includes status information, communication address and so on. For details, please refer to the definitions in standards, such as “A Model for Presence and Instant Messaging” of RFC 2778, and “Presence Information Data Format (PIDF)” of RFC3863 released by IETF. With reference to the terms in RFC 2778, an entity which provides a presence service with presence information is called as presentity, and an entity which requests presence information from a presence service is called as a watcher. Corresponding to a presence server which provides a presence service, the presentity and the watcher may be called as a presentity client and a watcher client respectively.

A systematic networking diagram of a presence service system is as illustrated in FIG. 1. As can be seen from FIG. 1, the presence service system includes:

a presence server, and a watcher client and a presentity client connected with the presence server. Presence information may be transmitted between the presentity client/the watcher client and the presence server through a presence protocol. The presence protocol may be based upon the Transmission Control Protocol (TCP) and the User Datagram Protocol (UDP), for example, employing the Session Initiation Protocol (SIP), referring to “A Presence Event Package for the Session Initiation Protocol (SIP)” of RFC3856. The presentity client and the watcher client may be typically custom terminals, such as mobile phones, computers and so on, and may also be an application server.

An existing flow for providing presence information is illustrated in FIG. 2, including the following steps.

101: Presence information of the presentity client changes. For example, a user gets online and changes from an offline status to an online status.

102: The presentity client publishes the changed presence information to the presence server.

103: The presence server updates recorded presence information of the presentity client with the received presence information.

104: The presence server distributes the updated presence information to the watcher client which has subscribed for the presence information of the presentity client.

105: The watcher client updates the recorded presence information of the presentity client with the received presence information and displays the updated presence information.

As illustrated in FIG. 3, the presence information typically includes a status element, such as status information of online, offline, busy, idle, absent, no interrupt and so on. Whether in the standards of IETF and OMA or in current commercial presence service systems such as MSN, the status element is a most essential and indispensable presence information. Additionally, position information is also a specific but not necessary status. Further included are a communication address element adapted to indicate contact address information of the presentity client and other indicating elements adapted to extend a new status or indicator, such as an information element of timestamp and so on. An example of the presence information described in the Extensible Markup Language (XML) is given below.

<presence entity=“user@example.com”>

<tuple><status><basic>open</basic></status></tuple>

<person>

<activities><meeting/></activities>
<mood><happy/></mood>

</person>

</presence>

As described in the above example, the presence information of a presentity client whose entity is user@example.com, includes the elements <tuple> and <person>, where the element <status><basic>open</basic></status>in the element <tuple>indicates that the presentity client is in a status of open, i.e. online available status; and the activity element <activities><meeting/></activities>in the element <person>indicates that the presentity client is currently in an activity of meeting, and the motion element <mood><happy/></mood>indicates that the presentity client is currently in a status of happy.

Although current commercially available presence service system (such as MSN from Microsoft Corp. and QQ from Tencent Corp.) and standards provided by the IETF provide rich presence information, the presentity client may provide only current presence information of the presentity client, and may not provide the watcher client with a desired validity period of the presence information. If a presentity user client is currently in an online status and may be in a situation that communication is not convenient after one hour, such as power-off for rest, at meeting, on a plane and so on, then the existing presence service may only inform the watcher client that the presentity client is currently in an online status, but may not inform the watcher client that he is not available one hour later. Thus the watcher may not be able to communicate with the presentity client in time.

### SUMMARY OF THE INVENTION

The present invention provides a method and system for providing presence information to solve the problem that only current presence information is provided while a watcher client may not be informed of a validity period or an invalid period of the presence information in the prior art.

The present invention provides a method for providing presence information, including:

setting a validity period of the presence information;

publishing, by a presentity client, the presence information and the validity period of the presence information to a presence server; and

distributing the received presence information and the validity period of the received presence information to a watcher client by the presence server; and

receiving and displaying the presence information of the presentity client and the validity period of the presence information by the watcher client.

The present invention provides a system for providing presence information, including a presence server, a presentity client and a watcher client, wherein:

the presentity client is adapted to publish the presence information and the validity period of the presence information to the presence server;

the presence server is adapted to distribute the received presence information and the validity period of the presence information to a watcher client; and

the watcher client is adapted to receive and display the presence information of the presentity client and the validity period of the presence information.

The method or system for providing presence information provided by the present invention includes: setting the validity period for the presence information, publishing the presence information and the validity period of the presence information to the presence server by the presentity client, and distributing the received presence information and validity period to the watcher client by the presence server. Thus, the watcher client may know the validity period of the presence information, such as the end time of the current presence information, and thereby choose an appropriate time for communication with the presentity client. Furthermore, the present invention also provides the start time of the current presence information, and thus the watcher client may know the duration of current presence information of the presentity client. In summary, only the presence information of current time may be provided to the user by the conventional presence service. The present invention introduces different time information relevant to presence information into the presence service, which is very useful.

### BRIEF DESCRIPTIONS OF THE DRAWINGS

FIG. 1 is a networking diagram of a presence service system in the prior art;

FIG. 2 is a flow chart of providing presence information in the prior art;

FIG. 3 is a structural diagram of presence information in the prior art;

FIG. 4 is a flow chart of the method according to an embodiment of the present invention;

FIG. 5 is a flow chart of separately providing a start time in the embodiment as illustrated in FIG. 4.

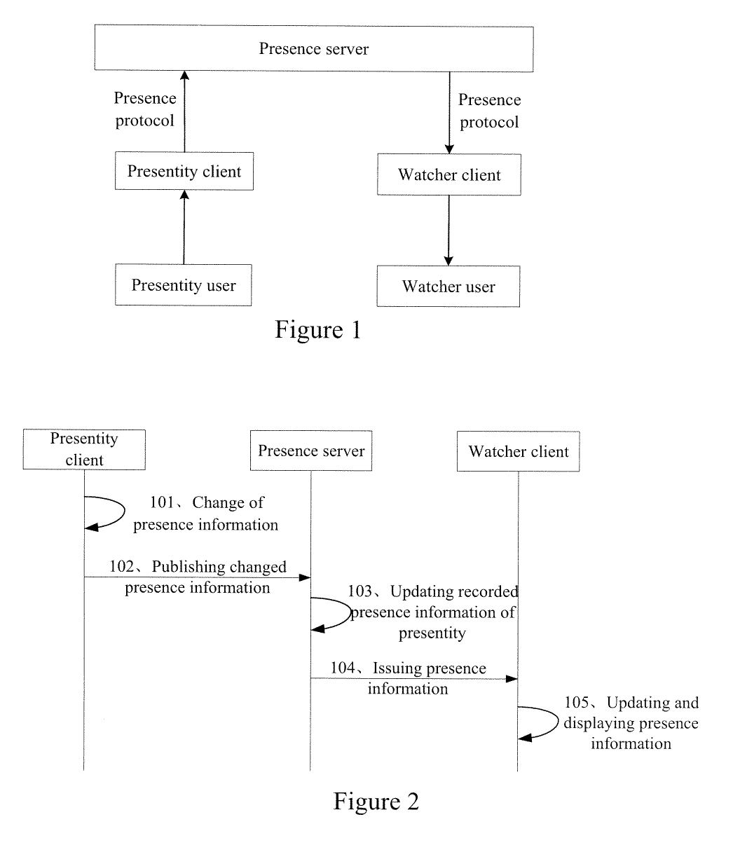

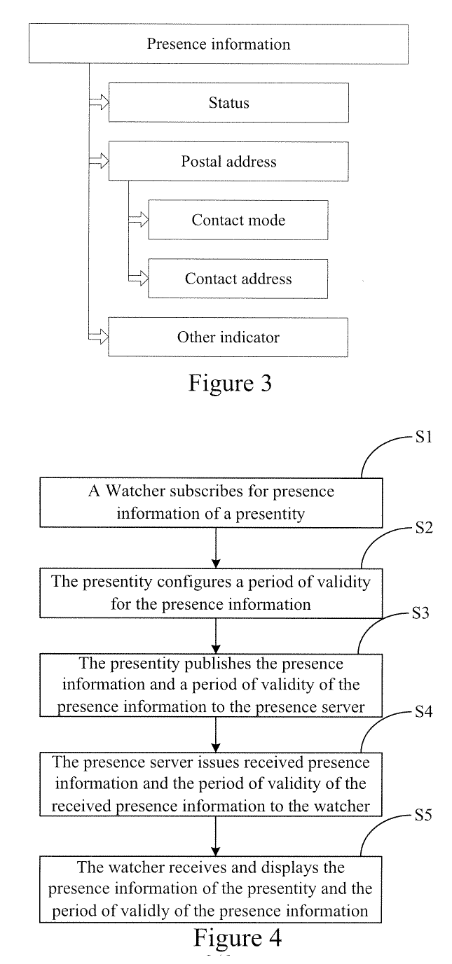

### DETAILED DESCRIPTIONS OF THE EMBODIMENTS

According to a first embodiment of the present invention, a system for providing presence information includes a presence server, a presentity client and a watcher client. In this embodiment, the presentity client publishes presence information and a validity period of the presence information to the presence server; the presence server distributes the received presence information and the validity period to the watcher client; and the watcher client receives and displays the presence information and the validity period of the presentity client. According to a second embodiment of the present invention, a system for providing presence information also includes a presence server, a presentity client, and a watcher client, but in this system, the presentity client publishes presence information to the presence server; the presence server distributes current presence information and a start time of current presence information to the watcher client and the watcher client receives the presence information of the presentity client and the start time of the presence information.

Specifically, in embodiments of the present invention, the presence information may be described with an Extensible Markup Language (XML) by way of an example. The information in the XML format may also be stored in a relational database. Typically, a corresponding validity period may be set only for part of the presence information, such as the most essential status element. First, a step of setting a validity period for presence information will be described in detail. A validity period may be typically set for the presence information at the presentity client. The validity period may be set in an attribute of a corresponding presence information element or in an element parallel to the corresponding presence information element or in a sub-element of the corresponding presence information element. The following is an example in which a validity period has been set for the presence information.

<presence entity=“user@example.com”>

<tuple>

<status><basic>open</basic></status>
<status-end-time>2005-04-24T16:00:00Z</status-end-time>
</tuple>

</presence>

Herein, the status element <status><basic>open</basic></status>has a value open for indicating an online status and a corresponding end-time element <status-end-time>in parallel with the status element for indicating that the status has a validity period until the time 2005-04-24T16:00:00 Z. A time indicating the validity period typically includes information on year, month, day, hour, minute, second and so on. In order that different systems and operators and even different countries may parse uniformly time information of the validity period, it is preferable to adopt a time format as defined in “Date and Time on the Internet: Timestamps” of RFC 3339. The time format defined by RFC 3339 may also include time zone information such as 2005-12-19T16:30:00-08:00, referring to the RFC 3339 standards for details. After receiving the presence information and the validity period, the watcher client converts the validity period into a local time in accordance with the time zone information, and then displays the presence information and the validity period of the presentity client.

Furthermore, the validity period may also be set in an attribute of a presence information element. The following is an example.

<presence entity=“user@example.com”>

<person>

<activities
until=“2005-05-30T17:00:00+05:00”><meeting/></activities>

</person>

</presence>

Herein, in the element <activities>, a validity period is set with the attribute until for indicating that an expected validity period for the current activity status of meeting is until 2005-05-30T17:00:00+05:00.

The validity period may also be set in a sub-element of a presence information element which is expected to be set with the validity period. The following is an example.

<presence entity=“user@example.com”>

<tuple><status>

<basic>open</basic>
<end-time>2005-04-24T14:30:00Z</end-time>

</status></tuple>
</presence>

Here, a sub-element <end-time> of the element <status>, e.g. <end-time>2005-04-24T14:30:00 Z</end-time>, defines a validity period of parent element <status>, in other words, the end time of the validity period is 2005-04-24T14:30:00 Z.

The presence information and the validity period may be obtained at the presentity client through an input from a user, and may also be obtained automatically from electric calendar data, such as iCalendar data or vCalendar data. The iCalendar is described in “Internet Calendaring and Scheduling Core Object Specification” of RFC 2445. For example, there may be the following iCalendar data:
DTSTART: 20050424T103000Z
DTEND: 20050424T120000Z
CATEGORIES: MEETING
SUMMARY: PROJECT PLAN REVIEW MEETING

From the above iCalendar data, the presentity client may take the DTEND or both the DTEND and the DTSTART as the validity period, and take the CATEGORIES as the presence information <activities>, and take the SUMMARY as text note information of <note>. Corresponding presence information is as follows.

<presence entity=“user@example.com”><person>

<activities from=“2005-04-24T10:30:00Z”

until=“2005-04-24T12:00:00Z”>

<meeting/>
<note xml:lang=“zh”> PROJECT PLAN REVIEWMEETING </note>
</activities>
</person></presence>

Herein, a corresponding language attribute lang may also be set in the text note information of <note>. If the presentity client detects that current time is within the validity period, then only sets an end time and neglects a start time. If the presentity client detects that the validity period is a future period, then sets both a start time and an end time. In addition to the current presence information, the presence information also includes future presence information defined with the validity period, and the future presence information may be separated from the current presence information through setting a corresponding validity period.

After setting the validity period for the presence information, the presentity client publishes the presence information and the validity period to the presence server. The presence server stores the received presence information and the validity period and distributes the received presence information and the validity period to the watcher client subscribing for the presence information. Generally, the watcher client may obtain the presence information of the presentity client from the presence server after the watcher client has subscribed for the presence information of the presentity client and has been authorized by the presentity client. When the presence server receives the presence information or sends a notification to the watcher client, if it is detected that an end time of the validity period corresponding to the presence information is earlier than current time, then deletes the validity period, or sends a notification to the presentity client for indicating that the validity period corresponding to the presence information has already be invalid. Moreover, if the watcher client also detects that an end time of the validity period corresponding to the presence information is earlier than current time, then deletes the validity period and displays the presence information.

After the presentity client publishes initial presence information and a validity period of the presence information to the presence server, the presentity client may only publish the changed validity period without the corresponding presence information. For example, if an end time of a meeting activity is postponed from 16:00 to 18:30 in the same day, then the presentity client may publish to the presence server the information on the changed validity period through a publish message of a presence protocol, such as SIP PUBLISH. A specific message of SIP PUBLISH may be given below for example.

PUBLISH sip: resource@example.com SIP/2.0

......
<?xml version=“1.0” encoding=“UTF-8”?>

<pidf-diff entity=“user@example.com” version=“2”>

<replace sel=“*/tuple[@id=‘q1140s’]/status-end-time/text( )”>
2005-04-24T18:30:00Z</replace>

</pidf-diff>

The SIP PUBLISH message sent by the presentity client contains an instruction <replace> for replacing with the changed validity period information, and specifies in the attribute sel the location of the validity period in the presence information document using the XPath which is described in relevant standards of World Wide Web Committee (W3C). After receiving the information, the presence server updates the status-end-time of the validity period stored for the presentity client user example.com with the changed validity period contained in the SIP PUBLISH message.

In addition, the presence server may also send the start time of the current presence information of the presentity client to the watcher client. The presence server compares the received current presence information published by the presentity client with the presence information of the presentity client stored on the presence server. If they are different or the presence server has stored no presence information of the presentity client, then the current time may be taken as a start time of the presence information and be stored. If they are same, then the start time of the stored presence information may be reserved. Alike, the start time may also adopt a time format as defined by RFC 3339. The start time may be set in an attribute of a corresponding presence information element or in an element parallel to a corresponding presence information element or in a sub-element of a corresponding presence information element. Unlike the validity period, the start time is typically set by the presence server.

The watcher client may display the presence information and the start time of the presentity client. Practically, a display of duration will be more apparent to a user, and the duration may be obtained by the watcher client from a difference between the current time and the start time. For example, if a start time corresponding to the activity element 20<activities><meeting/></activities> is 2005-04-24T16:00:00Z, and the current time is 2005-04-24T18:30:00Z, then the duration is the difference between the above two times, in other words, two hours and thirty minutes. Accordingly, a watcher may know that the current presence information, i.e. the meeting activity status has lasted two hours and thirty minutes.

In order to more fully describe the present invention, a further description will be given to an entire flow of a presence service with reference to steps illustrated in FIG. 4.

S1: The watcher client subscribes for the presence information of the presentity client. After receiving a subscription request from the watcher client, the presence server authenticates the subscription request in accordance with a right configuration of the presentity client. The presence server stores a subscription relationship after the authentication. In the right configuration of the presentity client, a policy may be set for the subscription request of the watcher client, for example, whether the watcher client designated with Uniform Resource Identifier (URI) (such as SIP URI, telephone number, e-mail box address and so on) or the domain watcher has a right for subscription, whether the subscription is required to be confirmed by the presentity client, etc. The presence server thus concludes whether the authentication result is an acceptance or refusal of the subscription, or suspends the subscription request and requests a confirmation for the presentity client. The authentication can be passed only when the presentity client returns a message for confirming an acceptance of the subscription. Alternatively, step S1 may also follow the step S2 or S3 described below.

S2: The presentity client sets a validity period for the presence information. The validity period is not essential information, and the presentity client may set no corresponding validity period for any presence information. Even if a validity period is provided, some old watcher clients may not be able to parse the validity period and neglect it. The presentity client may flexibly permit the user to set a validity period through various ways, not limited to the way of inputting an absolute time as a time for a validity period. For example, a length of time, such as 30 minutes, may be input for indicating that the validity period for current presence information will expire upon 30 minutes after current time. The presentity client may convert the non-absolute validity period into an absolute time when publishing the presence information and the validity period, in other words, using a time based on date and time.

S3: The presentity client publishes the presence information and the validity period to the presence server. Typically, each time when the presence information or the validity period changes, the presentity client sends the updated information to the presence server. In order to reduce network traffic, only the changed information may be transmitted. Optionally, all the presence information may also be transmitted.

S4: The presence information distributes the received presence information and the validity period to the watcher client. If a value of the presence information does not change relative to a value stored on the presence server, and only the validity period changes, then it is preferred to transmit the presence information and the validity period or only the validity period to the watcher client, so that the watcher user may know the latest validity period. Furthermore, when aggregating received identical presence information elements with identical values of the same presentity client, the presence server reserves the same presence information with different attributes of a validity period. Specifically, for the service element <tuple>, the personal element <person> and so on, whether attributes of their sub-elements are identical shall be taken into account for the aggregation in addition to whether values of the sub-elements are identical. If values of sub-elements <activities> of two elements <person> of the same presentity client are identical, but the attributes of the validity period are not identical, then the aggregation shall not be performed. By way of an example, one of the elements <person> is as follows:

<person>

<activities from=“2005-04-24T10:30:00Z”

until=“2005-04-24T12:00:00Z”>

<meeting/>
</activities>
</person>

<person>

<activities from=“2005-04-24T14:30:00Z”

until=“2005-04-24T16:00:00Z”>

<meeting/>
</activities>
</person>

The above two elements <person> respectively indicate that there is a meeting in each of the two periods of validity, and thus the elements shall not be combined or either of them can be neglected. Therefore, the presence server will not aggregate the above two elements <person> with sub-elements in confliction. The sub-elements in confliction refer to that elements with the same name have different values or attributes. The above elements with the name <activities> have different attributes, and thus are in confliction.

S5: The watcher client receives and displays the presence information and the validity period of the presentity client. If a start time of the presence information is contained, the duration obtained by current time and the start time may also be displayed as well. Since the duration is of a value changing with the current time, the watcher client may update the display duration in accordance with the current time periodically, such as per minute. Furthermore, if the watcher client does not care the validity period, then a filtering condition may be set upon subscription, and the information on the validity period may be filtered when the presence server sends a notification.

According to the present invention, the start time may not necessarily be provided along with the validity period, but may be provided separately. With respect to the start time, the presence server may compare the received current presence information published by the presentity client with the presence information of the presentity client stored on the presence server. If they are different or the presence server has stored no presence information of the presentity client, then the current time may be taken as the start time of the presence information, and be stored; and if they are identical, then the stored start time of the presence information may be reserved. In other words, the start time is based upon the time when the presence server receives the presence information. It typically takes several seconds from publication of the presence information by the presentity client to the reception by the presence server. Therefore, it will be no problem for the start time based upon the time when the presence server receives the presence information. Moreover, the time at server is typically more accurate than the time at client. Practically, the time may also be set by the presentity client and be published along with the corresponding presence information to the presence server. This procedure is similar to the procedure for setting a validity period, and the start time may be set in an attribute of a corresponding presence information element or in an element parallel to a corresponding presence information element or in a sub-element of a corresponding presence information element.

Providing the start time primarily intends to display the start time for the watcher client. The watcher may display both the presence information and the start time of the presentity client, or display the duration obtained by the watcher client from a difference between the current time and the start time.

The synchronous coordination between the presentity and the watcher may be implemented with the start time, for example, a synchronous playing for music and video. When a person finds that a friend of the person is playing music, the client may obtain and play the music automatically and make a playing progress same as that of the friend of the person according to the start time. When the presentity client locally plays the music and video, music or video information, such as the title, the source address, the size, and the start time for playing are published to the presence server as the presence information. After obtaining the music or video information and the start time, the watcher client plays the music or video synchronously based on the music or video information and start time. If no corresponding music or video file exists locally, the music or video file may be obtained using the source address in the presence information. In addition, music lyrics or video subtitles may be displayed to the presentity client synchronously, and the presentity client may search and obtain the music lyrics and the video subtitles according to the music or video information in the presence information, such as the title. The lyric file may be in an LRC format as shown below.

[ti:Hello Goodbye]

[ar:Cheyenne Kimball]

[al:The Day Has Come]

[00:00.00]07. Hello Goodbye

[00:02.47]Am I speaking Japanese

[00:04.46] I told you 20 times when neat

[00:07.11] but you still don't get it

Title information and so on is included. The time information, such as [00:02.47], is inserted before each sentence with a common format of [mm:ss.fff], i.e[minutes: seconds]. The subtitle file format, such as SRT, is similar as that of the song lyric file and a repeat description thereof is omitted. The watcher client calculates a playing duration according to the start time and adjusts the subtitles or lyrics displayed locally to a corresponding time point.

Except for the time zone, the time in the presentity client and the time in the watcher client may be different with respect to a standard time respectively, for example, a difference of a few seconds or minutes may exist. Therefore, the duration calculated by the watcher client according to the start time provided by the presentity client and the time of the watcher client may not be accurate. In order to improve the synchronous precision, the presentity client and the watcher client may be timed with respect to the presence server to which the presentity client and the watcher client pertain or other reference entity. A difference within a few seconds is acceptable. At present, many mobile phone terminals and computers may synchronize time with the network side automatically. Therefore, the start time provided by the presentity client may be used to calculate the duration directly.

In addition, because a local time may be early or later by a few minutes due to a reason or a personal configuration, the presentity client and the watcher client may both use the time of the presence server other than the local time. The presence server may carry the local time of the presence server in the Date or Timestamp head field of the NOTIFY message or 200 OK response message, and the client may obtain the time of the presence server after receiving the message. The transmission time for the message may be omitted because the transmission time is generally less than a few seconds. Optionally, the client may compensate for the transmission time by adding 1-2 seconds. The client may calculate the time difference between the client and the server by comparing the local time with the time in the received message. When the presentity client publishes the start time, the presentity adds the time difference to the local time as the start time. The watcher client subtracts the time difference from the obtained start time and calculates the duration according to the local time. Then, the duration is used for synchronization.

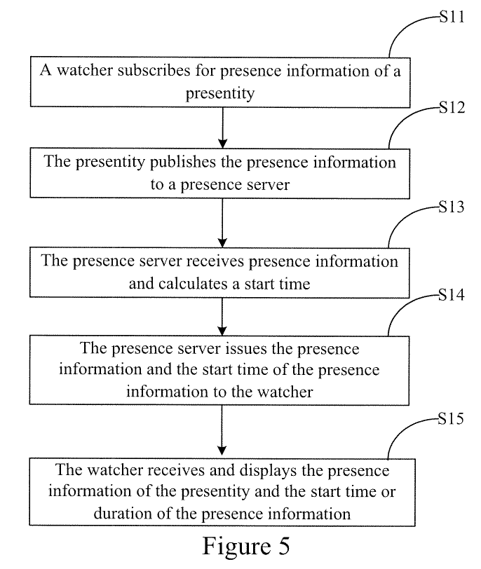

An example of separate provision of the start time is as illustrated in FIG. 5.

S11: The watcher client subscribes for the presence information of the presentity client.

S12: The presentity client publishes the presence information to the presence server.

S13: The presence server receives the presence information and calculates the start time.

S14: The presence server distributes the presence information and the start time to the watcher client.

S15: The watcher client receives and displays the presence information and the start time or duration of the presentity client.

As described in the following embodiment, the start time of the presence information is obtained mainly according to a specific request from the watcher. Generally, the watcher is not interested in start times of all presence information, and different watchers may be interested in start times of different presence information. Hence, it is not appropriate that the start time is sent to the watcher in the presence information by default. In addition, some watchers may not be interested in the start time at all. The method according to this embodiment may obtain a start time of a specified presence information element according to a specific request from a watcher. The method includes the following steps.

S21: The watcher client sends a subscription request, wherein the subscription request includes parameters such as an identifier for indicating a presence information element and whether start time information is needed. The format of the subscription request is described as below with a message SIP SUBSCRIBE as an example.

SUBSCRIBE sip:presentity@example.com
Event: Presence; starttime=“true”
<?xml version=“1.0” encoding=“UTF-8”?>
<filter-set xmlns=“urn:ietf:params:xml:ns:simple-filter”>

<ns-bindings>

<ns-binding prefix=“pidf” urn=“urn:ietf:params:xml:ns:pidf”/>

</ns-bindings>
<filter id=“123” uri=“sip:presentity@example.com”>

<what><include type=“xpath”>

/pidf:presence/pidf:tuple/pidf:status/pidf:basic

</include></what>

</filter>

</filter-set>

Part content of the message is omitted for brief. The identifier of the presence information element is described with XML language in the filtering message body of the request SUBSCRIBE, such as /pidf:presence/pidf:tuple/pidf:status/pidf:basic. While in the head field Event of the message, a parameter, such as starttime=“true”, is used to indicate that the start time of the subscribed presence information needs to be obtained. In the <ns-bindings>, a simplified character string is defined to replace a naming space identifier, for example, a prefix pidf represents a name space urn:ietf:params:xml:ns:pidf.

In addition to using the parameter starttime, it may be defined in the filtering message body directly that a start time element or attribute needs to be provided. For example, the main content of the filter is as follows.

<filter id=“123” uri=“sip:presentity@example.com”><what>

<include type=“xpath”>/presence/tuple/status/basic</include>

<include type=“xpath”>/presence/tuple/status/start-time</include>
</what></filter>

In a returned notification message, a status element <basic> and a corresponding start time element <start-time> are contained.

S22: After the presence server receives the subscription request, if it is determined that the start time needs to be provided according to the parameter in the subscription request, a presence information value and a corresponding start time are included in the notification message. For example, the content of the notification message is as follows.

<presence entity==“user@example.com”>

<tuple><status>

<basic>open</basic>
<start-time>2007-09-14T14:30:00Z</start-time>
</status></tuple>
</presence>

When the watcher client refreshes the subscription for next time, the above filter may be cancelled or replaced with a new filter.

More generally, a subscription mechanism for history presence information may be provided, and the start time and so on may not be required to be included as a part of the content of the presence information document. First, the presence server records presence information and a start time, an end time and the like of the presence information. The time when the value or the attribute of the presence information changes may also be recorded. In the following embodiment, a common acquisition mechanism for event history information, which is not limited to presence event, is provided. The client may use a SIP subscription/notification mechanism to obtain the event history information. In practice, a lot of event information is provided through the SIP subscription/notification mechanism. If the event history information is to be obtained by other protocols, such as HTTP or FTP, an addition protocol stack needs to be added by the client and the server.

In this embodiment, a history event template-package, such as history, is newly defined. In addition to event Presence, other events such as event conference, event winfo and event reg-event, may use the template-package history. The names of events and the name of the history event package are combined into an indication for obtaining the event history information, such as Presence. history and presence.winfo.history, and the indication may be set in the event head field Event of the subscription message. When the watcher wants to obtain the history event information, the watcher may send a subscription request to subscribe for the history information record of the presence event, wherein, an indication such as Presence.history is contained in the event head field Event of the subscription message.

Moreover, the time range of the history information to be obtained may be defined by event parameters, such as parameter from for defining the start time of the history information and parameter until or to for defining the end time of the history information. If the parameter until does not exist, the end time is current time by default. A parameter at represents a specific time at which the value of the history event information is obtained. If the parameters from and until do not exist, the start time of current event information is obtained by default. Also, the parameter start-time=“true” may be used to explicitly indicate that the start time of current event information is needed. Additionally, the parameters may be used at the same time. For example, parameters from and until may be used at the same time to define a time period.

Detail description will be given with the presence information as an example. For example, the content of a subscription request for obtaining presence information history at a time is shown below.

SUBSCRIBE sip:presentity@example.com

Event: Presence.history; at=“2007-09-14T14:10:00Z”

Additionally, a filter may be included in the content of the subscription message body to determine which history record information is to be provided. The filter may implement a similar function as parameters from and until. An example is shown as below.

SUBSCRIBE sip:presentity@example.com
Event: Presence.history
<?xml version=“1.0” encoding=“UTF-8”?>
<filter-set xmlns=“urn:ietf:params:xml:ns:simple-filter”
xmlns:h=“urn:ietf:params:xml:ns:history-filter”>

<ns-bindings>

<ns-binding prefix=“pidf” urn=“urn:ietf:params:xml:ns:pidf”/>

</ns-bindings>
<filter id=“123” uri=“sip:presentity@example.com”>

<what><include type=“xpath”>

/pidf:presence/pidf:tuple/pidf:status/pidf:basic

</include></what>
<h:periods>

<h:from>2007-09-11T14:10:00Z</h:from>

</h:periods>

</filter>

</filter-set>

The period element <periods> as time parameters may include elements <from>, <until> and <at > to define a time range for the history information to be obtained. An element <duration>, including a time length based on second, may also be used to indicate the history record to be obtained from current time to a time point, wherein the time length between the time point and the current time is defined in the above element <duration>.

For example, <duration>7200</duration>.

When the presence server receives the subscription request, the presence server obtains a corresponding history record in the presence event package according to the time parameter in the head field Event or information in the filter and returns the history information of the presence information element with a notification message NOTIFY. For example, the history record information in the notification message, in other words, the content of the event history information event package, is described as follows.

<historyinfo xmlns=“urn:ietf:params:xml:ns:history”>
<ns-bindings>
<ns-binding prefix=“pidf” urn=“urn:ietf:params:xml:ns:pidf”/>
</ns-bindings>
<history resource=“sip:tom@example.com” package=“presence”>
<node type=“xpath”>/pidf:presence/pidf:tuple/pidf:status/pidf:basic</node>
<value from=“2007-09-14T12:30:00Z” until=“2007-09-14T13:30:00Z”>
open</value>
</history>
</historyinfo>

The element <history> includes a node <node>, adapted to indicate the element or the attribute of the corresponding event package such as presence, and at least one corresponding value <value> in parallel. Each value may have different attribute values of from and until. The time intervals determined by the two attributes may not overlap with each other. The attribute value of until in one value <value> may be the attribute value of from in other parallel value <value>. When the watcher client requests the start time of current presence information, the value <value> in the returned event history information may only include the attribute value of from without the attribute value of until. When the watcher client requests the presence information at a time point, the value <value> in the returned element <history> may include the attribute values of from and until to indicate the start time and the end time of the history presence information at the time point between the start time and the end time.

Additionally, it is preferable to list the node element indicated in the <node> instead of giving the value of the node in <value> directly, because the node element may have some other attributes. If the node <node> includes a sub-element, the sub-element needs to be listed in <value> too. At least one element value or attribute is different in the different values <value> in parallel. The content of the record including a plurality of values <value> is shown as follows.

<history resource=“sip:joe@example.com” package=“presence”>
<node type=“xpath”>/pidf:presence/pidf:tuple/pidf:status/pidf:basic</node>
<value from=“2007-09-14T12:30:00Z” until=“2007-09-14T13:30:00Z”>
open</value>
<value from=“2007-09-14T13:30:00Z” until=“2007-09-14T15:30:00Z”>
close</value>
</history>

If it is expected that history information of several nodes is returned simultaneously, the element <node> and a corresponding element <value> are set in a parent element <nodelist> and history element <history> may include at least one element <nodelist>. Sub-elements <node> are different from each other to indicate different event information nodes.

Because the presentity may disconnect unexpectedly and connect again rapidly, the duration of some presence information value may be very short. The presence server may discard the history record of the presence information whose duration is shorter than a preset value such as three minutes. In other words, the server may not record the above short history information value.

In addition to providing common event history information, similarly, common event start time information may be provided directly and simply. For example, a start time template event package slarttime may be defined and combined with any other event packet. For example, Presence.starttime is defined by combining the starttime with the presence information. The subscription request for the start time of the presence information is shown as follows.

SUBSCRIBE sip:presentity@example.com

Event: Presence.starttime

A filter may be used in the subscription request message body to define which presence information element the start time is to be obtained from. If several presence information elements are specified in the filter or the presence information element includes several sub-elements, a start time corresponding to current status of each element is given respectively in a returned notification message. Part content of the filter is shown as below.

<filter id=“123” uri=“sip:presentity@example.com”>

<what><include type=“xpath”>

/presence/person/activities/meeting

</include></what>

</filter>

Because the node status when the server receives the request may be different from the client status when the client sends the request, for example, the event status information of the server changes after the client sends the request, a current status value or a timestamp in the event package document corresponding to current status may be included in the sent request to guarantee that the server is capable of accurately returning the start time of the status when the client sends the request. For example, the presence information document including the timestamp is shown as below.

<tuple id=“bs35r9”>

<status><basic>open</basic></status>
<timestamp>2007-09-14T16:49:29Z</timestamp>

</tuple>

The content of the corresponding filter is shown as below.

<filter id=“123” uri=“sip:presentity@example.com”>

<what><include type=“xpath”>

/presence/tuple[@id=“bs35r9”]/status/basic

</include></what>
<h:timestamp>2007-09-14T16:49:29Z</h:timestamp>

</filter>

Since the timestamp in a normal event package is sent when the server distributes the event information, the timestamp may be consistent with the server clock. The server determines whether the status of the event being requested for the start time is changed after receiving the time in the timestamp of the filter. If the status of the event is not changed, the server returns the start time of current status to the client, otherwise, the server returns the start time of the history event status corresponding to the timestamp to the client. If the server has not recorded the history event information, the server returns an error response for indicating that the information is unavailable to the client.

For example, the content of the notification message returned by the server is shown as below.

<startinfo xmlns=“urn:ietf:params:xml:ns:history”>
<ns-bindings>
<ns-binding prefix=“pidf” urn=“urn:ietf:params:xml:ns:pidf”/>
</ns-bindings>
<startlist resource=“sip:tom@example.com” package=“presence”>
<node type=“xpath”>/pidf:presence/pidf:tuple/pidf:status/pidf:basic</node>
<from>2007-09-14T12:30:00Z</from>
</startlist>
</startinfo>

The start time may be directly included in the element parallel to <value>, such as <from>, other than being included in the attribute of <value>. Thus, the element <value> may be omitted. Because the client has the current event status value, the current event status value is unnecessary to be sent to the client. If it is expected that start times of several nodes are returned at one time, the elements <node> and <from> may be included in a parent element, such as <starttime>, as sub-elements. In other words, an element <startlist> may include several elements <starttime> and each element <starttime> includes start time information of a node.

For simplifying the solution, the server may obtain the start time of each sub-node without recursion. When a node specified in the request for obtaining the start time includes sub-nodes, the start time closest to current time in each sub-node is used as the returned start time in the notification message.

If the start time or the history information of all event information is provided, the server needs to record a lot of information. However, for most of the event information, the user may not care the start time or the history information. Therefore, the server may only provide the start time or the history information for some of the event information other than all of the event information. Thus, the client needs to know which event information the start time or history information may be provided by the server before the client requests a start time or history information of event information. In this embodiment, the above process is implemented with the OPTIONS method in SIP. In other words, the client sends a SIP OPTIONS request to a server, and indicates that the event history or the type of the event start time is to be accepted in the head filed Accept, such as Accept: application/event-history and Accept: application/event-starttime. The head field Allow-Events in the response message returned by the server includes the supported event, such as presence.history and presence.starttime. The responded message body includes a content corresponding to the type in the head filed Accept of the request message. For example, the content of the message body of the event history type application/event-history, includes the identifiers of the nodes capable of providing the history event information. The client may only request the history event information of the nodes. If the client requests history event information of other nodes, the server returns an error response for indicating that no corresponding resource exists to the client.

Generally, the server may authenticate the request for subscribing for history information or the start time of an event. In this embodiment, the authentication for an existing event information subscription is used. If it is detected that the server has a subscription right for event information, the server has the subscription right for the history information or the start time of corresponding event. In addition, if the authentication information (such as common policy) includes transformations, the transformations are applied to a corresponding node value when event history information is provided. In particular, in terms of the provided position information, the accuracy of the position information is lowed after the transformations are applied, and correspondingly, history position information is provided with the same low accuracy.

The request for subscribing for the history information or the start time may use a one-time subscription. In other words, the value of the head field Expires may be set to zero. If the server finds that the value is not equal to zero, the server returns a notification and ends the subscription.

It is evident that those skilled in the art may make various changes and modifications to the present invention without departing from the spirit and scope thereof. Thus, the present invention is intended to include these changes and modifications provided that they fall within the scope of the appended claims and equivalents thereof.

What is claimed is:

1. A method for providing presence information, comprising:
publishing, by a presentity client, presence information and a validity period of the presence information to a presence server; and
receiving, by a watcher client, the presence information and the validity period distributed by the presence server.

2. The method according to claim 1, further comprises:
setting the validity period for the presence information; and
setting an end time of the presence information as the validity period of the presence information, the presence information being current presence information of the presentity client.

3. The method according to claim 1, further comprises:
setting a start time of the presence information as the validity period or a period corresponding to the start time and the end time of the presence information as the validity period and associating the validity period with the future presence information;
the presence information being a future presence information of the presentity client,

4. The method according to claim 1, wherein the presence information is contained in an XML document, and the validity period is set in an attribute of a corresponding presence information element, or in an element parallel to the corresponding presence information element, or in a sub-element of the corresponding presence information element.

5. The method according to claim 4, further comprising: setting text note information corresponding to the validity period for the presence information; and
publishing, by the presentity client, the presence information, the validity period, and the corresponding text note information to the presence server;
distributing, by the presence server, the received presence information, the validity period, and the corresponding text note information to the watcher client; and
receiving and displaying, by the watcher client, the presence information, the validity period, and the corresponding text note information of the presentity client.

6. The method according to claim 4, wherein, when aggregating the same presence information elements with identical values received from one presentity client, reserving, by the presence server or the watcher client, the same presence information with different attributes of the validity period.

7. The method according to claim 2, further comprising: when the presence server or the watcher client detects that the end time of the validity period corresponding to the presence information is earlier than current time, deleting the validity period.

8. The method according to claim 1, wherein: a start time of current presence information of the presentity client is distributed along with the corresponding presence information to the watcher client.

9. The method according to claim 8, wherein the watcher client displays the current presence information of the presentity client and the start time of the current presence information.

10. The method according to claim 8, wherein the watcher client displays the current presence information of the presentity client and a duration of the current presence information, the duration being obtained by the watcher client from a difference between a current time and the start time.

11. A method for providing presence information, comprising:
publishing, by a presentity client, the presence information to a presence server; and
distributing, by the presence server, current presence information of the presentity client and a start time of the current presence information to a watcher client.

12. The method according to claim 11, wherein the start time is obtained through the steps of:
comparing, by the presence server, the received current presence information published by the presentity client with presence information of the presentity client stored on the presence server; and
if the received current presence information and the presence information of the presentity client are different or the presence server has stored no presence information of the presentity client, taking and storing a current time as the start time of the presence information; otherwise,
reserving a stored start time of the presence information.

13. The method according to claim 11, wherein the start time is set by the presentity client and is published along with the corresponding presence information to the presence server.

14. The method according to claim 13, wherein, publishing, by the presentity client, music or video information played locally as the presence information and the start time for playing to the presence server; and playing, by the watcher client, a corresponding music or video or displaying a music lyrics or a video subtitle synchronously after receiving the music information or video information and the start time.

15. The method according to claim 14, wherein, using the time information in a message sent from the presence server, calculating, by the presentity client, the start time, and calculating, by the watcher client, a corresponding duration.

16. The method according to claim 11, wherein the presence information is contained in an XML document and the start time is set in an attribute of a corresponding presence information element, or in an element parallel to a corresponding presence information element, or in a sub-element of a corresponding presence information element.

17. The method according to claim 11, further comprising: displaying, by the watcher client, both the current presence information and the start time of the presentity client.

18. A system for providing presence information, comprising a presence server, a presentity client, and a watcher client, wherein:
the presentity client is adapted to publish the presence information and the validity period of the presence information to the presence server;
the presence server is adapted to distribute the received presence information and the validity period of the presence information to a watcher client; and
the watcher client is adapted to receive the presence information of the presentity client and the validity period of the presence information.

19. A method for providing event history information, comprising:
recording event information;
receiving a request for obtaining event history information sent by a client, the request being a SIP (Session Initiation Protocol) SUBSCRIBE request and the SUBSCRIBE request comprising an indication for obtaining event history information and a time parameter;
obtaining, by the server, recorded corresponding event history information, according to the indication and the time parameter in the SUBSCRIBE request; and
sending, by the server, the event history information to the client through a SIP NOTIFY message.

20. The method according to claim 19, wherein, a filter in a message body of the SUBSCRIBE request comprises the time parameter for determining a duration range of the event history information;
or, an event head filed of the SUBSCRIBE request comprises the time parameter.

21. The method according to claim 19, wherein, an element or an attribute node whose event history information is to be obtained is indicated with an XPath in the SUBSCRIBE request message.

22. The method according to claims 19, wherein, a NOTIFY message body sent by the server comprises a node identifier for an event information element, at least one corresponding event information value, and a start time and/or an end time corresponding to each event information value.

23. The method according to claim 19, wherein, the time parameter in the request indicates the event history information at a specified time point to be obtained, and the event history information sent by the server further comprises an actual start time and/or end time of the event history information at the specified time point.

24. The method according to claim 19, wherein, when the server receives the request for obtaining the event history information sent by the client and determines that the history information of current event status is to be obtained, the server sends a start time corresponding to current event status to a requesting client.

25. A method for providing a start time of event information, comprising:
recording, the start time of the event information;
receiving, a request for obtaining event history information sent by a client, the request being a SIP (Session Initiation Protocol) SUBSCRIBE request and an event head field in the SUBSCRIBE request comprising an indication for obtaining a start time of the event information, and a message body comprising a node identifier of the event information;
obtaining, by the server, the start time of corresponding event information according to the SUBSCRIBE request; and
sending, by the server, the start time of the corresponding event information to the client through a SIP NOTIFY message.
